(19) United States
(12) Patent Application Publication
(10) Pub. No.: US 2014/0067955 A1
(43) Pub. Date: Mar. 6, 2014

(54) INSTANT MEDIA SHARING TO DEFINED GROUPS BASED ON LOCATION

(71) Applicant: Picshare, Inc., New York, NY (US)

(72) Inventor: Nathaniel Christian, New York, NY (US)

(73) Assignee: Picshare, Inc., New York, NY (US)

(21) Appl. No.: 13/971,404

(22) Filed: Aug. 20, 2013

Related U.S. Application Data
(60) Provisional application No. 61/695,902, filed on Aug. 31, 2012.

(51) Int. Cl. H04L 29/06

(52) U.S. Cl. CPC H04L 65/60
USPC 709/204

(57) ABSTRACT

Disclosed are instant media sharing platforms, systems, and software comprising: mobile modules configured to determine geolocation, capture media, and transmit captured media to a server application, each captured media associated with a capture time and a capture geolocation; a database of geolocation information, the geolocation information associated with each user of the mobile application; and server modules configured to identify recipient users for each transmitted media, a recipient user present within a radius about a capture geolocation during a time interval about a capture time; and provide a media stream to each user of the mobile application, the media stream comprising transmitted media for which a user is identified as a recipient user, the media stream provided via the mobile application. Also disclosed are networks formed by and methods of using the same.

### CROSS-REFERENCE TO RELATED APPLICATIONS

This application claims the benefit of U.S. Provisional Application No. 61/695,902, filed Aug. 31, 2012, which is incorporated in its entirety herein by reference.

### BACKGROUND OF THE INVENTION

Photo sharing is a popular activity among internet users. According to an extrapolation of photo upload data reported by Facebook in 2011, the site now houses about 60 billion photos (more recent estimates put the number closer to 90 billion photos); whereas Photobucket contains 8 billion, Picasa contains 7 billion, and Flickr contains 5 billion photos.

### SUMMARY OF THE INVENTION

While media sharing (including photo sharing, video sharing, and the like) is popular, the content and subject matter are largely untargeted. Users often find shared media irrelevant and therefore uninteresting. Current technologies including, web photo album generators, photoblogs, and social network photo sharing fail to address the long-felt problem of media relevance. Moreover, traditional methods of media sharing require effort and technical skill.

The relevance of media content and subject matter is greatly improved by sharing with others present at the time and place the media was captured. For example, the attendees of a dinner party would find likely photos of the event interesting and relevant. However, emailing photos to the specific attendees after the fact is not effective, requiring individuals to remember to take the extra steps and effort necessary. Similarly, phone bumping requires users to have the same device or take extra effort to interact with each and every intended recipient.

Photo and video filters add interest to shared media, but current technologies are irreversible and destructive to the media.

Advantages of the platforms, networks, systems, software, and methods described herein include, but are not limited to dramatically improving the relevance of media by sharing based on time and place rather than a user's technical or social capabilities. Advantages also include instant media sharing that is effortless and provides access to non-destructive, reversible media filters.

In one aspect, disclosed herein are instant media sharing platforms comprising: a mobile processor configured to provide a mobile application comprising: a software module configured to determine geolocation; a software module configured to capture media; a software module configured to transmit captured media to a server application, each captured media associated with a capture time and a capture geolocation; a server processor configured to provide a server application comprising: a database of geolocation information, the geolocation information associated with each user of the mobile application; a software module configured to identify recipient users for each transmitted media, the recipient users identified by presence within an area during a time window, the area defined by a radius about a capture geolocation, the time window defined by a time interval about a capture time; a software module configured to provide a media stream to each user of the mobile application, the media stream comprising transmitted media for which a user is identified as a recipient user, the media stream provided via the mobile application. In some embodiments, the geolocation information associated with each user is updated substantially continuously. In some embodiments, the media comprises a photograph or a video. In some embodiments, the capture time and capture geolocation is associated with captured media as metadata. In further embodiments, the metadata is embedded in the media. In some embodiments, the radius is about 10 to about 10,000 meters. In further embodiments, the radius is about 100 to about 5,000 meters. In still further embodiments, the radius is about 250 to about 1,000 meters. In a particular embodiment, the radius is about 500 meters. In some embodiments, the time interval is about 10 to about 10,000 seconds. In further embodiments, the time interval is about 100 to about 5,000 seconds. In still further embodiments, the time interval is about 200 to about 1,000 seconds. In a particular embodiment, the time interval is about 300 seconds. In some embodiments, mobile application further comprises a software module configured to view a media stream. In some embodiments, the mobile application further comprises a software module configured to apply one or more media filters to captured media. In further embodiments, the software module configured to transmit captured media to a server application transmits a filtered and an unfiltered version of the media. In further embodiments, the software module configured to transmit captured media to a server application transmits a filter setting and an unfiltered version of the media. In still further embodiments, the one or more media filters are non-destructive and reversible. In some embodiments, the mobile application further comprises a software module configured to create and present a gallery of captured media. In some embodiments, the media stream comprises reduced size reference media. In some embodiments, the mobile application further comprises a software module configured to allow download of media in the media stream in full size. In further embodiments, the mobile application further comprises a software module configured to allow purchase of media in the media stream in full size. In some embodiments, the mobile application further comprises a software module configured to manage captured media sharing settings. In further embodiments, the sharing settings comprise an unlimited mode and a limited mode. In still further embodiments, the limited mode is a “friends” mode. In some embodiments, the mobile application further comprises a software module configured to manage media stream receipt settings. In further embodiments, the receipt settings comprise an unlimited mode and a limited mode. In still further embodiments, the limited mode is a “friends” mode. In some embodiments, the mobile application further comprises a software module configured to share captured media to one or more online destinations, such as social networking or content sharing applications.

In another aspect, disclosed herein are computer-readable storage media encoded with a computer program including instructions executable by a processor to create a mobile application for instant media sharing, the mobile application comprising: a software module configured to determine geolocation; a software module configured to capture media; a software module configured to transmit captured media to a server, each captured media associated with a capture time and a capture geolocation; and a software module configured to view an individual media stream provided by the server, the media stream comprising transmitted media for which a user is identified as a recipient user, a recipient user present within a radius about a capture geolocation during a time interval about a capture time. In some embodiments, geolocation information is updated substantially continuously. In some embodiments, the media comprises a photograph or a video. In some embodiments, the capture time and capture geolocation is associated with captured media as metadata. In further embodiments, the metadata is embedded in the media. In some embodiments, the radius is about 10 to about 10,000 meters. In further embodiments, the radius is about 100 to about 5,000 meters. In still further embodiments, the radius is about 250 to about 1,000 meters. In a particular embodiment, the radius is about 500 meters. In some embodiments, the time interval is about 10 to about 10,000 seconds. In further embodiments, the time interval is about 100 to about 5,000 seconds. In still further embodiments, the time interval is about 200 to about 1,000 seconds. In a particular embodiment, the time interval is about 300 seconds. In some embodiments, the mobile application further comprises a software module configured to apply one or more media filters to captured media. In further embodiments, the software module configured to transmit captured media to a server transmits a filtered and an unfiltered version of the media. In further embodiments, the software module configured to transmit captured media to a server transmits a filter setting and an unfiltered version of the media. In still further embodiments, the one or more media filters are non-destructive and reversible. In some embodiments, the mobile application further comprises a software module configured to create and present a gallery of captured media. In some embodiments, the individual media stream comprises reduced size reference media. In some embodiments, the mobile application further comprises a software module configured to allow download of media in the individual media stream in full size. In further embodiments, the mobile application further comprises a software module configured to allow purchase of media in the individual media stream in full size. In some embodiments, the mobile application further comprises a software module configured to manage captured media sharing settings. In further embodiments, the sharing settings comprise an unlimited mode and a limited mode. In still further embodiments, the limited mode is a “friends” mode. In some embodiments, the mobile application further comprises a software module configured to manage media stream receipt settings. In further embodiments, the receipt settings comprise an unlimited mode and a limited mode. In still further embodiments, the limited mode is a “friends” mode. In some embodiments, the mobile application further comprises a software module configured to share captured media to one or more online destinations, such as social networking or content sharing services.

In another aspect, disclosed herein are computer-readable storage media encoded with a computer program including instructions executable by a processor to create a server application for instant media sharing, the server application comprising: a database of geolocation information, the geolocation information associated with each user of a mobile application; a software module configured to receive media, each media captured and transmitted by a user of the mobile application, each media associated with a capture time and a capture geolocation; and a software module configured to provide an individual media stream to each user of the mobile application, the media stream comprising received media for which a user is identified as a recipient user, a recipient user present within a radius about a capture geolocation during a time interval about a capture time. In some embodiments, geolocation information is updated substantially continuously. In some embodiments, the media comprises a photograph or a video. In some embodiments, the capture time and capture geolocation is associated with captured media as metadata. In further embodiments, the metadata is embedded in the media. In some embodiments, the radius is about 10 to about 10,000 meters. In further embodiments, the radius is about 100 to about 5,000 meters. In still further embodiments, the radius is about 250 to about 1,000 meters. In a particular embodiment, the radius is about 500 meters. In some embodiments, the time interval is about 10 to about 10,000 seconds. In further embodiments, the time interval is about 100 to about 5,000 seconds. In still further embodiments, the time interval is about 200 to about 1,000 seconds. In a particular embodiment, the time interval is about 300 seconds. In some embodiments, one or more filters are applied to the media. In further embodiments, the one or more filters are non-destructive and reversible. In some embodiments, the individual media stream comprises reduced size reference media. In some embodiments, the server application further comprises a software module configured to allow purchase of media in the individual media stream in full size. In some embodiments, the software module configured to provide an individual media stream to each user of the mobile application determines recipient users by user-configured media sharing and media receipt settings.

In another aspect, disclosed herein are computer-implemented methods for instant media sharing, the method comprising the steps of: determining, by a mobile computer, geolocation for a user; transmitting, by the mobile computer, media to a server, each media associated with a capture time and a capture geolocation; and providing, by the mobile computer, an individual media stream received from the server, the media stream comprising transmitted media for which a user is identified as a recipient user, a recipient user present within a radius about a capture geolocation during a time interval about a capture time. In some embodiments, geolocation is updated substantially continuously. In some embodiments, the media comprises a photograph or a video. In some embodiments, the capture time and capture geolocation is associated with captured media as metadata. In further embodiments, the metadata is embedded in the media. In some embodiments, the radius is about 10 to about 10,000 meters. In further embodiments, the radius is about 100 to about 5,000 meters. In still further embodiments, the radius is about 250 to about 1,000 meters. In a particular embodiment, the radius is about 500 meters. In some embodiments, the time interval is about 10 to about 10,000 seconds. In further embodiments, the time interval is about 100 to about 5,000 seconds. In still further embodiments, the time interval is about 200 to about 1,000 seconds. In a particular embodiment, the time interval is about 300 seconds. In some embodiments, the method further comprises the step of applying one or more filters to the media. In further embodiments, the one or more filters are non-destructive and reversible.

In another aspect, disclosed herein are computer-implemented methods for instant media sharing, the method comprising the steps of: maintaining, at a server, a database of geolocation information, the geolocation information associated with each user of a mobile application; receiving media, by the server, each media captured and transmitted by a user of the mobile application, each media associated with a capture time and a capture geolocation; and providing, by the sever, an individual media stream to each user of the mobile application, the media stream comprising received media for which a user is identified as a recipient user, a recipient user present within a radius about a capture geolocation during a time interval about a capture time. In some embodiments, geolocation is updated substantially continuously. In some embodiments, the media comprises a photograph or a video. In some embodiments, the capture time and capture geolocation is associated with captured media as metadata. In further embodiments, the metadata is embedded in the media. In some embodiments, the radius is about 10 to about 10,000 meters. In further embodiments, the radius is about 100 to about 5,000 meters. In still further embodiments, the radius is about 250 to about 1,000 meters. In a particular embodiment, the radius is about 500 meters. In some embodiments, the time interval is about 10 to about 10,000 seconds. In further embodiments, the time interval is about 100 to about 5,000 seconds. In still further embodiments, the time interval is about 200 to about 1,000 seconds. In a particular embodiment, the time interval is about 300 seconds. In some embodiments, the method further comprises the step of applying one or more filters to the media. In further embodiments, the one or more filters are non-destructive and reversible.

In another aspect, disclosed herein are computer-based instant media sharing networks comprising a server processor configured at least to: maintain a database of a plurality of users, wherein each user is associated with a current geolocation; receive media captured and transmitted the plurality of users, each media associated with a capture time and a capture geolocation; and provide an individual media stream to each of the plurality of users, the media stream comprising received media for which a user is identified as a recipient user, a recipient user present within a radius about a capture geolocation during a time interval about a capture time. In some embodiments, geolocation is updated substantially continuously. In some embodiments, the media comprises a photograph or a video. In some embodiments, the capture time and capture geolocation is associated with captured media as metadata. In further embodiments, the metadata is embedded in the media. In some embodiments, the radius is about 10 to about 10,000 meters. In further embodiments, the radius is about 100 to about 5,000 meters. In still further embodiments, the radius is about 250 to about 1,000 meters. In a particular embodiment, the radius is about 500 meters. In some embodiments, the time interval is about 10 to about 10,000 seconds. In further embodiments, the time interval is about 100 to about 5,000 seconds. In still further embodiments, the time interval is about 200 to about 1,000 seconds. In a particular embodiment, the time interval is about 300 seconds. In some embodiments, one or more filters are applied to the media. In further embodiments, the one or more filters are non-destructive and reversible.

### BRIEF DESCRIPTION OF THE DRAWINGS

FIG. 1 shows a non-limiting, exemplary flow diagram for an instant media sharing platform/system; in this case, an instant media sharing platform/system comprising a server to share photos between a first and a second mobile device based on time, location, and user-configured permissions.

FIG. 2 shows non-limiting examples of a mobile graphic user interface (GUI) for configuring media sharing permission settings (A); in this case, a GUI offering an unlimited “all” mode (B), wherein sharing is based only on time and location; and a limited “friends” mode (C), wherein sharing is based on time, location, and connection status within a social network.

FIG. 3 shows non-limiting examples of mobile GUIs for using the camera of a mobile device to capture media; in this case, a GUI offering features to control a still camera function (A), features to control a video camera function (B), and tools to apply image filters to captured media (C).

FIG. 4 shows non-limiting examples of mobile GUIs for displaying incoming and outgoing media streams; in this case, an incoming stream of shared media for which a user is determined to be a recipient based on time and location (A) and an outgoing stream of media captured and shared by the user (B).

FIG. 5 shows non-limiting examples of a mobile GUI for displaying details for captured and/or shared media; in this case, a GUI for displaying an incoming photo/video (A) including information on the user that captured the photo/video, the time, date, and location of capture, and an element to download a full-resolution version of the photo/video; and a GUI for displaying an outgoing photo/video (B) including elements to configure sharing permissions, to delete the photo/video from media streams, and a list of users who have downloaded full-resolution version of the photo/video.

FIG. 6 shows non-limiting examples of mobile GUIs for sharing captured media to one or more social networking or sharing services; in this case, a GUI adapted for sharing photos (A) and a GUI adapted for sharing videos (B).

FIG. 7 shows a non-limiting example of a mobile GUI for configuring push notification settings; in this case, a GUI offering features to toggle notifications when a new photo is added to the user's media stream and when a new photo shared by a friend is added to the user's media stream.

### DETAILED DESCRIPTION OF THE INVENTION

Described herein, in certain embodiments, are instant media sharing platforms comprising: a mobile processor configured to provide a mobile application comprising: a software module configured to determine geolocation; a software module configured to capture media; a software module configured to transmit captured media to a server application, each captured media associated with a capture time and a capture geolocation; a server processor configured to provide a server application comprising: a database of geolocation information, the geolocation information associated with each user of the mobile application; a software module configured to identify recipient users for each transmitted media, the recipient users identified by presence within an area during a time window, the area defined by a radius about a capture geolocation, the time window defined by a time interval about a capture time; a software module configured to provide a media stream to each user of the mobile application, the media stream comprising transmitted media for which a user is identified as a recipient user, the media stream provided via the mobile application.

Also described herein, in certain embodiments, are computer-readable storage media encoded with a computer program including instructions executable by a processor to create a mobile application for instant media sharing, the mobile application comprising: a software module configured to determine geolocation; a software module configured to capture media; a software module configured to transmit captured media to a server, each captured media associated with a capture time and a capture geolocation; and a software module configured to view an individual media stream provided by the server, the media stream comprising transmitted media for which a user is identified as a recipient user, a recipient user present within a radius about a capture geolocation during a time interval about a capture time.

Also described herein, in certain embodiments, are computer-readable storage media encoded with a computer program including instructions executable by a processor to create a server application for instant media sharing, the server application comprising: a database of geolocation information, the geolocation information associated with each user of a mobile application; a software module configured to receive media, each media captured and transmitted by a user of the mobile application, each media associated with a capture time and a capture geolocation; and a software module configured to provide an individual media stream to each user of the mobile application, the media stream comprising received media for which a user is identified as a recipient user, a recipient user present within a radius about a capture geolocation during a time interval about a capture time.

Also described herein, in certain embodiments, are computer-implemented methods for instant media sharing, the method comprising the steps of: determining, by a mobile computer, geolocation for a user; transmitting, by the mobile computer, media to a server, each media associated with a capture time and a capture geolocation; and providing, by the mobile computer, an individual media stream received from the server, the media stream comprising transmitted media for which a user is identified as a recipient user, a recipient user present within a radius about a capture geolocation during a time interval about a capture time.

Also described herein, in certain embodiments, are computer-implemented methods for instant media sharing, the method comprising the steps of: maintaining, at a server, a database of geolocation information, the geolocation information associated with each user of a mobile application; receiving media, by the server, each media captured and transmitted by a user of the mobile application, each media associated with a capture time and a capture geolocation; and providing, by the sever, an individual media stream to each user of the mobile application, the media stream comprising received media for which a user is identified as a recipient user, a recipient user present within a radius about a capture geolocation during a time interval about a capture time.

Also described herein, in certain embodiments, are computer-based instant media sharing networks comprising a server processor configured at least to: maintain a database of a plurality of users, wherein each user is associated with a current geolocation; receive media captured and transmitted the plurality of users, each media associated with a capture time and a capture geolocation; and provide an individual media stream to each of the plurality of users, the media stream comprising received media for which a user is identified as a recipient user, a recipient user present within a radius about a capture geolocation during a time interval about a capture time.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Platforms and Networks

In some embodiments, the platforms, networks, systems, software, and methods described herein, are in communication and functionally connected to create an instant media sharing network. An instant media sharing network includes any suitable number of mobile users and media capture/sharing applications. In various embodiments, an instant media sharing network suitably includes, by way of non-limiting examples, 1, 2, 3, 4, 5, 6, 7, 8, 9, 10, 100, 200, 300, 400, 500, 600, 700, 800, 900, 1000, 2000, 3000, 4000, 5000, 6000, 7000, 8000, 9000, 10000 or more mobile users and media capture applications, including increments therein. In various further embodiments, an instant media sharing network suitably includes, by way of non-limiting examples, 10000, 100000, 1000000, 10000000, 100000000 or more mobile users and media capture/sharing applications, including increments therein. In light of the disclosure provided herein, those of skill in the art will recognize that high numbers of mobile users operating media capture/sharing applications and participating in the instant media sharing network extends the effectiveness of the network.

An instant media sharing network includes any suitable number of servers and server applications. In various embodiments, an instant media sharing network suitably includes, by way of non-limiting examples, 1, 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, 1000 or more servers and server applications, including increments therein. In other embodiments, an instant media sharing network suitably includes a server application provided by distributed computing or cloud computing services and/or platforms and, in some cases, utilize a variable number of servers.

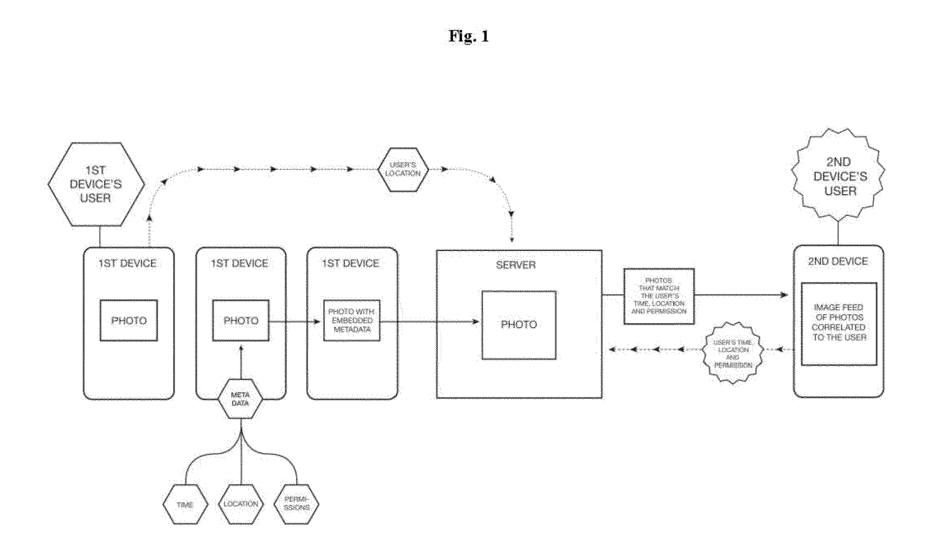

Referring to FIG. 1, in a particular embodiment, a first mobile user utilizes a mobile application described herein, which is installed and running on a mobile device to capture a photo. In this embodiment, metadata including media capture time, media capture location, and media sharing permission settings, are embedded in the captured media file. Further in this embodiment, the photo with embedded metadata is transmitted to a server application. At the server, the photo is matched with recipient users of the mobile application. In this embodiment, recipient users are determined by presence near the media capture location near the time the media was captured. In this embodiment, recipient users are further determined by media receipt permission settings. Recipient users, such as a second user, receive a low-bandwidth reference version of the media in an incoming media stream via the mobile application.

### Media

In some embodiments, the platforms, networks, systems, software, and methods described herein include software modules for capture, transmission, and filtering of media, or use of the same. In further embodiments, the platforms, networks, systems, software, and methods described herein include software modules for providing individualized media streams comprising media, or use of the same. Many types of media are suitable. In some embodiments, suitable media include photographs (e.g., static images), videos (e.g., motion images), audio, or combinations of the same.

Many image media formats are suitable including, by way of non-limiting examples, Joint Photographic Experts Group (JPEG), JPEG 2000, Exchangeable image file format (EXIF), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), wireless bitmap (WBMP), and WebP. In some embodiments, images are uncompressed (e.g., RAW format). In other embodiments, images are compressed. Both lossy and lossless image CODECs are suitable.

Many video media formats are suitable including, by way of non-limiting examples, Windows® Media Video (WMV), Windows® Media®, Motion Picture Experts Group (MPEG), Audio Video Interleave (AVI), Apple® QuickTime®, RealMedia®, Flash Video, Motion JPEG (M-JPEG), WebM, and Advanced Video Coding High Definition (AVCHD). In some embodiments, video is uncompressed (e.g., RAW format). In other embodiments, video is compressed. Both lossy and lossless video CODECs are suitable including, by way of non-limiting examples, DivX™, Cineform, Cinepak, Dirac, DV, FFV1, H.263, H.264, H.264 lossless, JPEG 2000, MPEG-1, MPEG-2, MPEG-4, On2 Technologies (VPS, VP6, VP7, and VP8), RealVideo, Snow lossless, Sorenson Video, Theora, and Windows Media Video (WMV).

In some embodiments, photographs and/or video media are standard-definition. In other embodiments, photographs and/or video media are high-definition. In further embodiments, a high-definition photograph or video frame includes at least about 1280×about 720 pixels or at least about 1920×about 1080 pixels.

Many audio formats are suitable including, by way of non-limiting examples, MP3, WAV, AIFF, AU, Apple® Lossless, MPEG-4, Windows Media®, Vorbis, AAC, and Real Audio®.

In some embodiments, the platforms, networks, systems, software, and methods described herein utilizes media capture hardware integral to, or associated with, a mobile processing device to capture media. In further embodiments, a software module configured to capture media utilizes one or more of a camera, a video camera, and a microphone of a mobile processing device to capture media.

### Geolocation

In some embodiments, the platforms, networks, systems, software, and methods described herein include a software module for geolocating a user, a user's mobile device, and/or the location of media capture, or use of the same. In some embodiments, the platforms, networks, systems, software, and methods described herein include a database of geolocation information.

In some embodiments, geolocation information is associated with each user of a mobile application described herein. In further embodiments, geolocation information is the current location of each user of a mobile application described herein. In some embodiments, geolocation information includes historic location information for each user of a mobile application described herein.

In some embodiments, geolocation information is associated with each media captured and shared using the platforms, networks, systems, software, and methods described herein. In further embodiments, geolocation information is the location in which the media was captured.

For reference, geolocation is the identification of the real-world geographic location of an object, such as a mobile smartphone or an Internet-connected computer. A location is suitably expressed in a number of ways including, by way of non-limiting examples, geographic coordinates (e.g., latitude and longitude), a place name (e.g., county, city, landmark, intersection, etc.), a physical street address, distance from a given location, presence within a specified radius from a given location, and a graphical depiction on a map. In some cases, geolocation involves geocoding to find associated latitude and longitude from other geographic data. In some cases, geolocation involves reverse geocoding to back code latitude and longitude coordinates to a readable address or place name.

Many methods of geolocation are suitable that utilize several underlying sources of location information. In some embodiments, a software module geolocates, for example, a user or a media capture location using sources of location information including, by way of non-limiting examples, GPS coordinates provided by a processing device, triangulation between mobile phone towers and public masts (e.g., assistive GPS), Wi-Fi connection location, WHOIS performed on IP address or MAC address, GSM/CDMA cell IDs, and location information self-reported by a user. In some embodiments, location information includes position (e.g., latitude and longitude), elevation, heading, speed, orientation, and combinations thereof.

In some embodiments, a software module geolocates, for example, a user or a media capture location using the HTML 5 geolocation API. In light of the disclosure provided herein, those of skill in the art will recognize that the HTML 5 geolocation API is supported in Internet Explorer 9.0+, Firefox 3.5+, Safari 5.0+, Chrome 5.0+, Opera 10.6+, iOS 3.0+, Android 2.0+, and Windows Phone 7.5+. In some embodiments, a software module geolocates, for example, a news event or a contributor using methods aligned with W3C Geolocation API (available at: http://dev.w3.org/geo/api/spec-source.html). The W3C Geolocation API defines an interface to location information associated with a processing device (e.g., smartphone, tablet computer, laptop computer, etc.) hosting the implementation, such as latitude and longitude.

In some embodiments, the platforms, networks, systems, software, and methods disclosed herein perform geolocation by one method, such as those disclosed herein. In other embodiments, the platforms, networks, systems, software, and methods disclosed herein perform geolocation by more than one method.

In some embodiments, the geolocation of, for example, a user or a media capture location is accurate to within at least 100, 90, 80, 70, 60, 50, 40, 30, 20, 10, 9, 8, 7, 6, 5, 4, 3, 2, 1 or fewer kilometers, including increments therein. In further embodiments, the geolocation is accurate to within at least 1000, 900, 800, 700, 600, 500, 400, 300, 200, 100, 90, 80, 70, 60, 50, 40, 30, 20, 10, 9, 8, 7, 6, 5, 4, 3, 2, 1 or fewer meters, including increments therein

In some embodiments, the geolocation of a user is updated in a database, for example, once a day, once an hour, once a minute, or once a second, including increments therein. In further embodiments, the geolocation of a contributor is updated in the database on a continuous or substantially continuous basis to provide real-time or substantially real-time location information.

In some embodiments, a software module for geolocating a user and/or a user's mobile device keeps a historic log of locations. In further embodiments, a historic log of locations creates a map of each user's movement and travel. In some cases, a user powers off a mobile device, disables location services on a mobile device, or closes all running processes of a mobile application, such that location is not available. In such cases, a software module for geolocating a user and/or a user's mobile device updates historic location records in a database when the user powers the device back on, reactivates location services, and/or restarts the mobile application.

### Media Capture

In some embodiments, the platforms, networks, systems, software, and methods described herein include a software module configured to capture media, or use of the same. In further embodiments, a software module configured to capture media utilizes media capture hardware integral to, or associated with, a mobile processing device. In still further embodiments, a software module configured to capture media utilizes one or more of a camera, a video camera, and a microphone of a mobile processing device to capture media.

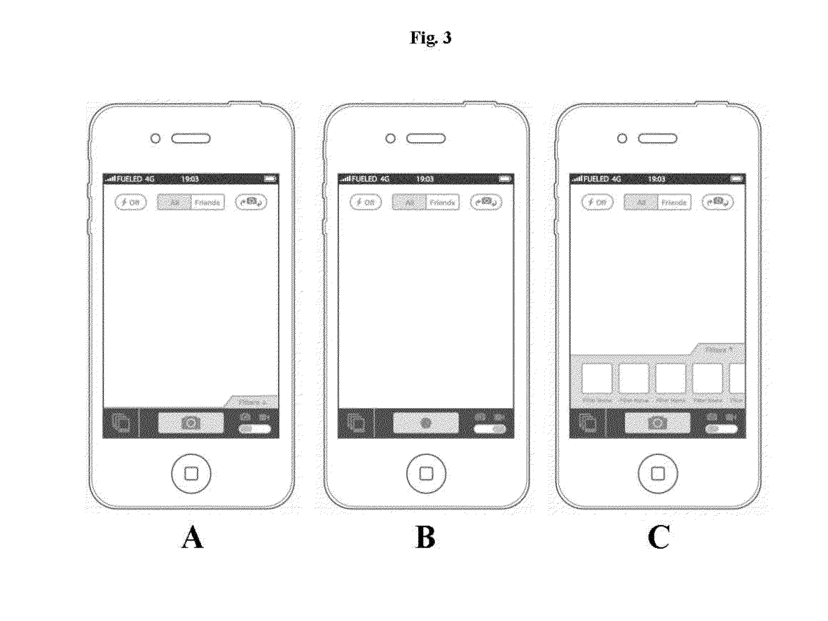

Referring to FIG. 3A, in a particular embodiment, a mobile application described herein includes a GUI for operating a camera of a mobile processing device to capture media. In this embodiment, a GUI includes elements to activate/deactivate a flash, toggle between still and video photography, switch cameras, configure sharing permission settings for media, and access media filters.

Referring to FIG. 3B, in a particular embodiment, a mobile application described herein includes a GUI for operating a video camera of a mobile processing device to capture media. In this embodiment, a GUI includes elements to activate/deactivate a flash, toggle between still and video photography, switch cameras, and configure sharing permission settings for media.

In some embodiments, each media captured is associated with a media capture time (i.e., the time the media was captured). In some embodiments, a media capture time includes a date. In further embodiments, a date includes year, month, and day of capture. In some embodiments a media capture time includes a time. In further embodiments, a time includes hour, minute, and second of capture. In some embodiments, a media capture time is recorded in 12-hour clock style. In other embodiments, a media capture time is recorded in 24-hour clock style. In some embodiments, a media capture time is recorded in Coordinated Universal Time (UTC). In some embodiments, a media capture time is recorded in the local time zone of media capture. In some embodiments, a media capture time is derived from a mobile processing device. In other embodiments, a media capture time is derived from a remote computer, such as a time synchronization server or an instant media sharing server configure to receive captured media. In further embodiments, a media capture time is derived by Network Time Protocol (NTP). In some embodiments, a media capture time is used, at least in part, to determine appropriate recipient users for shared media.

In some embodiments, each media captured is associated with a media capture location or geolocation time (i.e., the place the media was captured). In some embodiments, a media capture location includes a latitude and longitude. In further embodiments, a media capture location includes an elevation. In still further embodiments, latitude and longitude are recorded in degrees, minutes, and seconds. In other embodiments, a media capture location is recorded as a place name (e.g., county, city, landmark, intersection, etc.), a physical street address, distance from a given location, presence within a specified radius from a given location, or a graphical depiction on a map. In some embodiments, a media capture location includes heading, speed, and/or orientation of the user or the mobile processing device at the time the media was captured. In some embodiments, a media capture location or geolocation is used, at least in part, to determine appropriate recipient users for shared media.

In some embodiments, a media capture time and/or location is associated with media as metadata. As used herein, “metadata” is data providing information about one or more aspects of media. In some embodiments, metadata provides information about aspects of media such as: means of creation of the media, purpose of the media, time and date of creation of the media, creator or author of media, location where the media was created, and/or standards used to create the media. By way of non-limiting example, a digital photograph optionally includes metadata that describes how large the picture is, the color depth, the image resolution, when the image was created, where the image was created, and other data. By way of further non-limiting example, metadata is optionally written into a digital photo file that will identify who owns it, copyright, information, contact information, what camera created the file, along with exposure information and descriptive information such as keywords about the photo, making the file searchable on a computer and/or the Internet. In some cases, metadata is written by the camera. In other cases, metadata is input by the photographer and/or software after the media is created. In some embodiments, metadata includes notes, comments, and/or annotations made by the capturing user.

In some embodiments, metadata adheres to one or more photographic metadata standards including, but not limited to, IPTC Information Interchange Model IIM (International Press Telecommunications Council), IPTC Core Schema for XMP, Extensible Metadata Platform (XMP), Exchangeable image file format (Exif), Dublin Core Metadata Initiative (DCMI) and Picture Licensing Universal System (PLUS).

In some embodiments, a media capture time, a media capture location, and/or other data is associated with media by storage in a file separate from the media. In other embodiments, a media capture time, a media capture location, and/or other data is associated with media by embedding that data in the media file.

### Media Transmission

In some embodiments, the platforms, networks, systems, software, and methods described herein include a software module configured to transmit captured media to a server application described herein, or use of the same. In various embodiments, a software module configured to transmit captured media (e.g., photos, videos, and/or audio, etc.) utilizes many suitable communications channels. In some embodiments, a software module configured to transmit captured media utilizes wired or fiber optic telephone, wired or fiber optic Internet, Wi-Fi, cellular phone networks, and the like, including combinations thereof. In various embodiments, a software module configured to transmit captured media utilizes a wide array of suitable communications protocols. In some embodiments, a software module configured to transmit captured media utilizes wired communications protocols. In some embodiments, a software module configured to transmit captured media utilizes wireless communications protocols. In further embodiments, suitable communications protocols include, by way of non-limiting examples, 3G (3rd generation mobile telecommunications), 4G (4th generation mobile telecommunications), and geosynchronous and low Earth orbit (LEO) satellite, or combinations thereof. In further embodiments, suitable communications protocols include, by way of non-limiting examples, transmission control protocol/internet protocol (TCP/IP), hypertext transfer protocol (HTTP), hypertext transfer protocol secure (HTTPS), file transfer protocol (FTP), user datagram protocol (UDP), internet message access protocol (IMAP), post office protocol (POP), simple mail transfer protocol (SMTP), and simple network management protocol (SNMP), or combinations thereof.

In some embodiments, a software module configured to transmit captured media (e.g., photos, videos, and/or audio, etc.) utilizes web-based communications including, by way of non-limiting examples, HTTP methods such as GET and POST, web services, instant message, Internet fax, electronic mail, or combinations thereof.

In other embodiments, a module for telecommunications (e.g., photos, videos, and/or audio, etc.) utilizes cellular network-based communications including, by way of non-limiting examples, SMS, MMS, or combinations thereof. In some embodiments, a module for telecommunications provides real-time (e.g., synchronous) or near real-time (e.g., asynchronous) communication or transfer of data and/or information.

In some embodiments, captured media are transmitted to a server application in full size (e.g., at full capture size and resolution). In other embodiments, captured media are transmitted to a server application as reference media with reduced size (e.g., at a lower size and/or resolution). In some embodiments, captured media are provided to recipient users in a media stream in full size (e.g., at full capture size and resolution). In other embodiments, captured media are provided to recipient users in a media stream with reduced size (e.g., at a lower size and/or resolution). In such embodiments, recipient users optionally request (e.g., download, purchase, etc.) high-resolution versions of the reference media.

### Media Sharing

In some embodiments, the platforms, networks, systems, software, and methods described herein include a software module configured to identify recipient users for each media transmitted by a user of a mobile application described herein, or use of the same.

In some embodiments, a software module configured to identify recipient users for each transmitted media identifies users based, at least in part, on the user's presence (current or historic) within a particular area. In further embodiments, recipient users for each transmitted media are identified based, at least in part, on the user's presence (current or historic) near the media capture location. In still further embodiments, recipient users for each transmitted media are identified based, at least in part, on the user's presence (current or historic) within an area defined by a radius from the media capture location. Many radii are suitable depending on the desired number of shared media and the desired relevance of shared media. In various embodiments, suitable radii about a capture location include, by way of non-limiting examples, 5, 10, 15, 20, 25, 30, 35, 40, 45, 50, 55, 60, 65, 70, 75, 80, 85, 90, 95, 100 or more meters, including increments therein. In various further embodiments, suitable radii about a capture location include, by way of non-limiting examples, 100, 200, 300, 400, 500, 600, 700, 800, 900, 1000 or more meters, including increments therein. In various further embodiments, suitable radii about a capture location include, by way of non-limiting examples, 1000, 2000, 3000, 4000, 5000, 6000, 7000, 8000, 9000, 10000, 20000, 30000, 40000, 50000 or more meters, including increments therein.

In some embodiments, a software module configured to identify recipient users for each transmitted media identifies users based, at least in part, on the user's presence within a particular area at a particular time. In further embodiments, recipient users for each transmitted media are identified based, at least in part, on the user's presence near the media capture location near the media capture time. In still further embodiments, recipient users for each transmitted media are identified based, at least in part, on the user's presence within an area defined by a radius from the media capture location during a time window defined by a time interval about the media capture time. Many time intervals are suitable depending on the desired number of shared media and the desired relevance of shared media. In various embodiments, suitable time intervals about a capture time include, by way of non-limiting examples, 5, 10, 15, 20, 25, 30, 35, 40, 45, 50, 55, 60, 65, 70, 75, 80, 85, 90, 95, 100 or more seconds, including increments therein. In various further embodiments, suitable time intervals about a capture time include, by way of non-limiting examples, 100, 200, 300, 400, 500, 600, 700, 800, 900, 1000 or more seconds, including increments therein. In various further embodiments, suitable time intervals about a capture time include, by way of non-limiting examples, 1000, 2000, 3000, 4000, 5000, 6000, 7000, 8000, 9000, 10000, 20000, 30000, 40000, 50000 or more seconds, including increments therein.

In some embodiments, a software module configured to identify recipient users for each transmitted media identifies users based, at least in part, on media sharing permission settings configured by the user capturing the media and/or media receipt permission settings configured by a user identified as a recipient user for shared media.

In some embodiments, media sharing permission settings include an unlimited mode wherein the capturing user indicates that they desire to share the media with all users of the platforms, networks, systems, and software described herein. In some embodiments, media sharing permission settings include a limited mode wherein the capturing user indicates that they desire to share the media with a subset of users of the platforms, networks, systems, and software described herein. In further embodiments, a limited mode includes a “friends” mode wherein a user indicates that they desire to share the media with only their connections within one or more social networking, social media, or content sharing applications and/or services. In other embodiments, subsets of users are identified manually by name, screen name, and the like.

In some embodiments, media receipt permission settings include an unlimited mode wherein the user indicates that they desire to receive media captured by all users of the platforms, networks, systems, and software described herein. In some embodiments, media receipt permission settings include a limited mode wherein the user indicates that they desire to receive media captured by a subset of users of the platforms, networks, systems, and software described herein. In further embodiments, a limited mode includes a “friends” mode wherein a user indicates that they desire to receive media captured by only their connections within one or more social networking, social media, or content sharing applications and/or services. In other embodiments, subsets of users are identified manually by name, screen name, and the like.

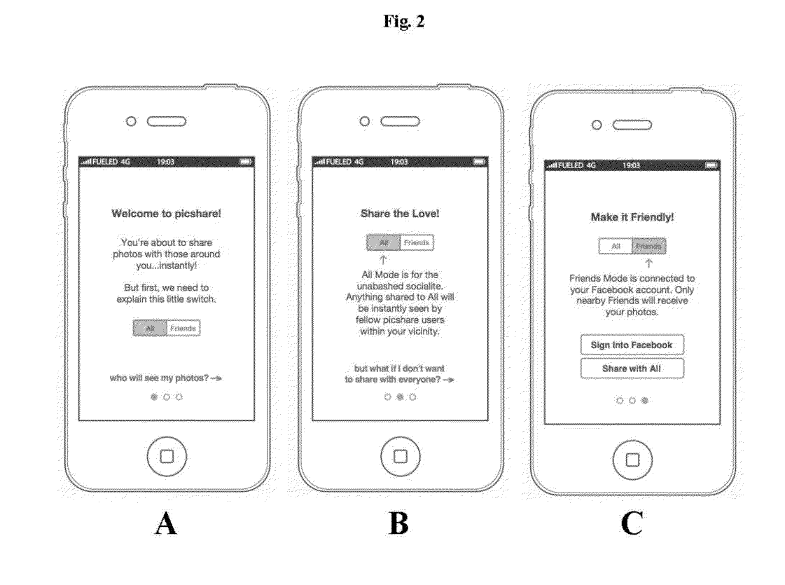

Referring to FIG. 2A, in a particular embodiment, a mobile application described herein includes a GUI for configuring media sharing permission settings. In this embodiment, settings include an unlimited “all” mode and a limited “friends” mode.

Referring to FIG. 2B, in a particular embodiment, the GUI depicted in FIG. 2A, further explains an unlimited “all” mode for captured media sharing.

Referring to FIG. 2C, in a particular embodiment, the GUI depicted in FIG. 2A, further explains a limited “friends” mode for captured media sharing and offers elements to log into a social network to determine the identity of the user's friends.

In some embodiments, the platforms, networks, systems, software, and methods described herein include a software module configured to automatically identify recipient users for captured media based on the criteria described herein such as presence (current or historic) within a particular area, presence within a particular area at a particular time, media sharing permission settings, and combinations thereof. In further embodiments, the identification of recipients and the transmission of captured media to the identified recipients proceed without a capturing user having to select or otherwise identify any recipients.

### Providing a Media Stream

In some embodiments, the platforms, networks, systems, software, and methods described herein include a software module configured to provide a media stream to each user of the mobile application. In further embodiments, the media stream comprises media (e.g., captured and transmitted by other users) for which a user is identified as a recipient user. In still further embodiments, the media stream is provided via a mobile application described herein.

In some embodiments, a media stream includes media reference files that are reduced in size and/or resolution compared to the full capture size and resolution. In further embodiments, full size and resolution images are optionally available to users upon request (e.g., download, purchase, etc.).

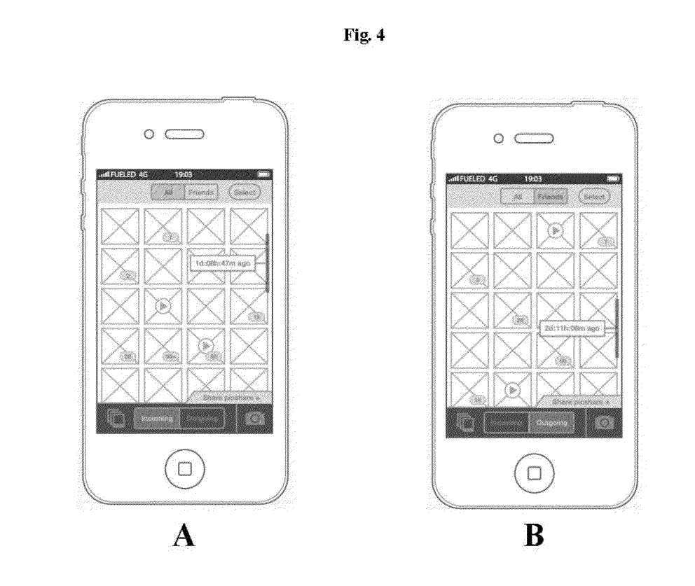

Referring to FIG. 4A, in a particular embodiment, a mobile application described herein includes a GUI for providing a user with an incoming media stream. In this embodiment, an incoming media stream includes photos and videos captured by others users for which the user is identified as a recipient user based on their proximity to the capture location and time for each media file.

Referring to FIG. 4B, in a particular embodiment, a mobile application described herein includes a GUI for providing a user with an outgoing media stream. In this embodiment, an outgoing media stream includes photos and videos captured by the user that will be shared with other users.

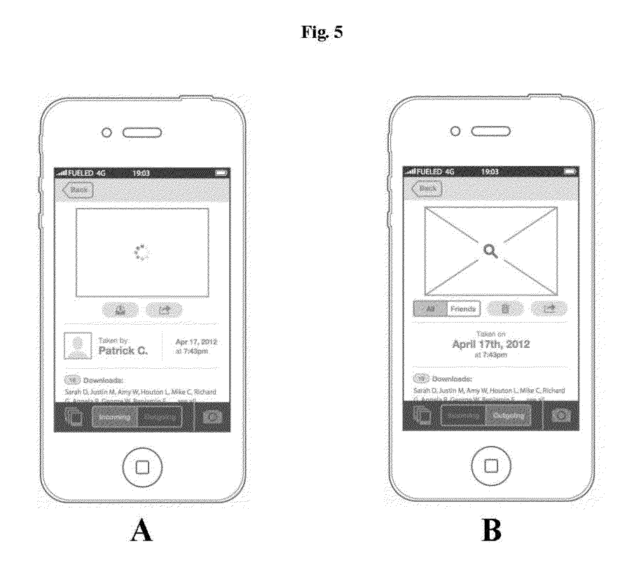

Referring to FIG. 5A, in a particular embodiment, a user optionally selects a media from an incoming media stream and views a larger version of the media as well as details for the media. In this embodiment, available details include the author of the media, the media capture location, the media capture time, the number of downloads that have been requested by recipient users, and any notes, comments, or annotations the author made.

Referring to FIG. 5B, in a particular embodiment, a user optionally selects a media from an outgoing media stream and views a larger version of the media as well as details for the media. In this embodiment, available details include the media capture location, the media capture time, the number of downloads that have been requested by recipient users, and any notes, comments, or annotations the user made when they captured the media.

In some embodiments, the platforms, networks, systems, software, and methods described herein include a software module configured to automatically provide a stream of media (e.g., captured and transmitted by other users) for which a user is identified as a recipient user. In further embodiments, the provision of the media stream proceeds without a capturing user having to select or otherwise identify any recipients. In still further embodiments, the provision of the media stream proceeds without a recipient user having to select or otherwise identify any media or capturing users.

### Media Filters

In some embodiments, the platforms, networks, systems, software, and methods described herein include a software module configured to apply one or more filters to captured media, or use of the same. In further embodiments, media filters are photo filters, video filters, or audio filters.

In some embodiments, a software module configured to apply filters to captured media applies a plurality of filters simultaneously. In various embodiments, a software module configured to apply filters to captured media applies a 2, 3, 4, 5, 6, 7, 8, 9, 10, 11, 12, 13, 14, 15, 16, 17, 18, 19, or more filters simultaneously. In other embodiments, a software module configured to apply filters to captured media applies a one filter at a time.

In some embodiments, a software module configured to apply filters to captured media applies one or more filters to a plurality of media simultaneously. In various embodiments, a software module configured to apply filters to captured media applies one or more filters to 2, 3, 4, 5, 6, 7, 8, 9, 10, 11, 12, 13, 14, 15, 16, 17, 18, 19, 20 or more media simultaneously. In other embodiments, a software module configured to apply one or more filters to captured media applies filters to one media at a time.

Many types of media filters are suitable. In some embodiments, suitable media filters include color filters, such as color levels, color balance, color separation, color overlay, duotone, and the like. In some embodiments, suitable media filters include visual effect filters, such as blur (e.g., linear blur, radial blur, motion blur, etc.), sharpen, glow, posterize, distort, pixelate, sketch, brush strokes, pen lines, pencil lines, and the like. In some embodiments, suitable media filters include vintage filters, such as sepia, black & white, age, noise, and the like. In some embodiments, suitable media filters include image framing filters, such as Polaroid, scrapbook, ornate, photo corners, and the like. In some embodiments, suitable media filters include audio effect filters, such as distort, slow, speed, pitch, music, and the like.

In some embodiments, a software module configured to apply one or more filters to captured media is non-destructive. In further embodiments, a software module configured to apply one or more filters to captured media has a reversible effect on media. In some embodiments, the platforms, networks, systems, software, and methods described herein store filtered and non-filtered versions of media separately. In further embodiments, media are shared in a non-filtered form and are associated with filter settings to enable reversible filters. In further embodiments, filter settings are associated with media as metadata. In still further embodiments, filter setting metadata is embedded in the media.

Referring to FIG. 3C, in a particular embodiment, mobile application described herein includes a GUI for reversibly applying photo filters to captured media.

### Commerce

In some embodiments, the platforms, networks, systems, software, and methods described herein include a software module configured to allow download of any of the media in an individual media stream in full size (e.g., full resolution), or use of the same. In further embodiments, the platforms, networks, systems, software, and methods described herein include a software module configured to allow purchase of and of the media in an individual media stream, or use of the same. In further embodiments, a user optionally purchases a full resolution version of any media for which they are identified as a recipient user. In some embodiments, purchased media is delivered in a physical format by mail, courier, or the like. In some embodiments, purchased media is delivered electronically by email, MMS, FTP, web page (HTTP), or the like.

The inventions disclosed herein include business methods. In some embodiments, the platforms, networks, systems, and software disclosed herein are marketed, advertised, and sold as, for example, products for instant media sharing. In some embodiments, the mobile and/or server applications disclosed herein are marketed, advertised, and distributed as, for example, instant media sharing applications and software. In other embodiments, the platforms, networks, systems, software, and methods are marketed, advertised, and sold (or distributed) as, for example, services for instant media sharing. In further embodiments, the services are provided as platform as a service (PaaS). In further embodiments, the services are provided as software as a service (SaaS).

### Sharing to Third-Party Online Destinations

In some embodiments, the platforms, networks, systems, software, and methods described herein include a software module configured to share captured media to one or more third-party online destinations, or use of the same. Many online destinations are suitable for sharing content including, by way of non-limiting examples, email, instant messaging, social networks, blogs, content sharing platforms, and the like. By way of further examples, suitable online destinations include Badoo, Bebo, Blogger, Blogster, Buzzfeed, CafeMom, Classmates.com, Delicious, DeviantART, Digg, Diglo, Facebook, FARK, Flixster, Flickr, Fotolog, Foursquare, Friendfeed, Friends Reunited, Friendster, Google+, Habbo, Linkedln, Livejournal, Meetup, Mixi, Mylife, Myspace, MyYearbook, Netlog, Ning, Pingsta, Pinterest, Plaxo, Reddit, Slashdot, SoundCloud, Stumbleupon, Tagged, Tumblr, Tweetmeme, Twitter, Yammer, Yelp, and the like.

In further embodiments, suitable online destinations include photo sharing applications including, by way of non-limiting examples, Facebook, Flickr, Fotki, Imageshack, Imgur, Jalbum, Kodak Gallery, KoodibooK, Lockerz, Mobile Me, Panoramio, Phanfare, Photobucket, Picasa, Piczo.com, Pinterest, Pixable, Posterous, SmugMug, Snapfish, Shutterfly, Streamzoo, Twitter, Webshots, WikiAlbums, Windows Live Photos, Woophy, and the like.

In further embodiments, suitable online destinations include those offering video sharing applications including, by way of non-limiting examples, Blinkx, Blip.tv, BlogTV, Buzznet, Crackle, EngageMedia, ExpoTV, Facebook, Flickr, Fotki, Gawkk, Hulu, Lafango, Liveleak, MaYoMo, Mefeedia, Metacafe, Mevio, Myspace, MyVideo, OneWorldTV, Openfilm, Ourmedia, Panopto, Photobucket, Podblanc, ReelTime.com, SmugMug, Twitvid, Veoh, Viddler, Vidyard, Vimeo, Vuze, Vzaar, Wistia, Yahoo! Video, YouTube, Zoopy, and the like.

In some embodiments, a software module configured to share captured media to one or more third-party online destinations allows selection of a plurality of captured media for simultaneous sharing to one or more third-party online destinations. In various embodiments, a software module configured to share captured media to one or more third-party online destinations allows selection of 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 200, 300, 400, 500 or more captured media, including increments therein, for simultaneous sharing to one or more third-party online destinations. In other embodiments, a software module configured to share captured media to one or more third-party online destinations allows selection of one captured media at a time.

In some embodiments, a software module configured to share captured media to one or more third-party online destinations allows simultaneous sharing to a plurality of third-party online destinations. In various embodiments, a software module configured to share captured media to one or more third-party online destinations allows simultaneous sharing to 2, 3, 4, 5, 6, 7, 8, 9, 10, 11, 12, 13, 14, 15, 16, 17, 18, 19, 20, 25, 30, 35, 40, 45, 50 or more third-party online destinations, including increments therein. In other embodiments, a software module configured to share captured media to third-party online destinations allows sharing to one third-party online destination at a time.

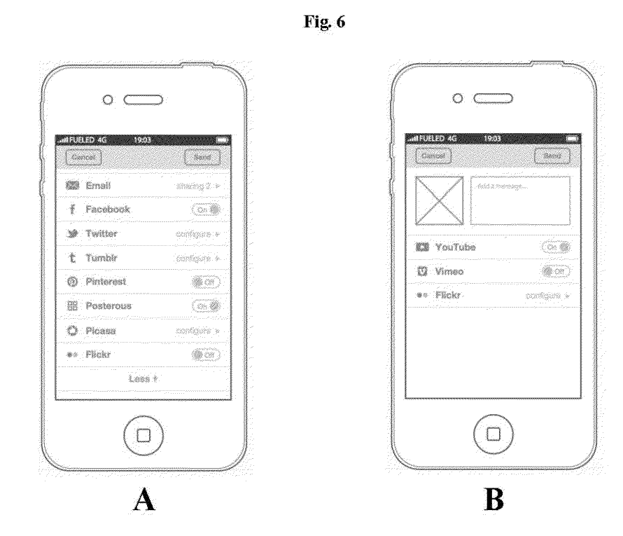

Referring to FIG. 6A, in a particular embodiment, a mobile application described herein includes a GUI for sharing captured media to one or more online or mobile photo sharing applications/services.

Referring to FIG. 6B, in a particular embodiment, a mobile application described herein includes a GUI for sharing captured media to one or more online or mobile video sharing applications/services.

### Notifications

In some embodiments, the platforms, networks, systems, software, and methods described herein include a software module configured to provide notifications upon the occurrence of user-configured events. In further embodiments, user-configured events include, by way of non-limiting examples, addition of a media to a user's media stream, addition of a media to a user's media stream that was captured by a friend, addition of media to a user's media stream that depicts the user, download or purchase of media captured by the user, and the like.

Many types of notifications are suitable. In various embodiments, suitable notifications include, by way of non-limiting examples, email, SMS, MMS, instant message, social media post, blog post, and the like. In further embodiments, suitable notifications include push notification to a mobile application.

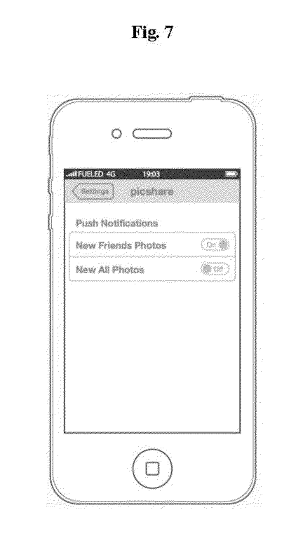

Referring to FIG. 7, in a particular embodiment, a mobile application described herein includes a GUI for activating/deactivating notifications triggered by additions of new media to a user's media stream. In this embodiment, a user separately configures notifications triggered by media shared by all other users and notifications triggered by media shared by friends.

### Digital Processing Device

In some embodiments, the platforms, networks, systems, software, and methods described herein include a digital processing device, or use of the same. In further embodiments, a digital processing device includes one or more hardware central processing units (CPU) that carry out the device's functions. In still further embodiments, a digital processing device further comprises an operating system configured to perform executable instructions. In some embodiments, a digital processing device is optionally connected a computer network. In further embodiments, a digital processing device is optionally connected to the Internet such that it accesses the World Wide Web. In still further embodiments, a digital processing device is optionally connected to a cloud computing infrastructure. In other embodiments, a digital processing device is optionally connected to an intranet. In other embodiments, a digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, a digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft Windows Mobile® OS, Linux®, and Palm® WebOS®.

In some embodiments, a digital processing device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, a digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, a digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, a digital processing device includes a digital camera. In some embodiments, a digital camera captures digital images. In some embodiments, the digital camera is an autofocus camera. In some embodiments, a digital camera is a charge-coupled device (CCD) camera. In further embodiments, a digital camera is a CCD video camera. In other embodiments, a digital camera is a complementary metal-oxide-semiconductor (CMOS) camera. In some embodiments, a digital camera captures still images. In other embodiments, a digital camera captures video images. In various embodiments, suitable digital cameras include 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, and higher megapixel cameras, including increments therein. In some embodiments, a digital camera is a standard definition camera. In other embodiments, a digital camera is an HD video camera. In further embodiments, an HD video camera captures images with at least about 1280×about 720 pixels or at least about 1920×about 1080 pixels. In some embodiments, a digital camera captures color digital images. In other embodiments, a digital camera captures grayscale digital images. In various embodiments, digital images are stored in any suitable digital image format. Suitable digital image formats include, by way of non-limiting examples, Joint Photographic Experts Group (JPEG), JPEG 2000, Exchangeable image file format (Exif), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), and WebP. In various embodiments, digital images are stored in any suitable digital video format. Suitable digital video formats include, by way of non-limiting examples, AVI, MPEG, Apple® QuickTime®, MP4, AVCHD®, Windows Media®, DivX™, Flash Video, Ogg Theora, WebM, and RealMedia.

### Non-Transitory Computer Readable Storage Medium

In some embodiments, the platforms, networks, systems, software, and methods disclosed herein include one or more non-transitory computer readable storage media encoded with a program including instructions executable by the operating system of an optionally networked digital processing device. In further embodiments, a non-transitory computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, networks, systems, software, and methods disclosed herein include at least one computer program, or use of the same. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. A web application for providing a career development network for artists that allows artists to upload information and media files, in some embodiments, includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Software Modules

The platforms, networks, systems, software, and methods disclosed herein include, in various embodiments, software, server, and database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. An instant media sharing platform comprising:
a. a mobile processor configured to provide a mobile application comprising:
i. a software module configured to determine geolocation;
ii. a software module configured to capture media;
iii. a software module configured to transmit captured media to a server application, each captured media associated with a capture time and a capture geolocation;
b. a server processor configured to provide a server application comprising:
i. a database of geolocation information, the geolocation information associated with each user of the mobile application;
ii. a software module configured to identify recipient users for each transmitted media, the recipient users identified by presence within an area during a time window, the area defined by a radius about a capture geolocation, the time window defined by a time interval about a capture time;
iii. a software module configured to provide a media stream to each user of the mobile application, the media stream comprising transmitted media for which a user is identified as a recipient user, the media stream provided via the mobile application.

2. The platform of claim 1, wherein the geolocation information associated with each user is updated substantially continuously.

3. The platform of claim 1, wherein the media comprises a photograph or a video.

4. The platform of claim 1, wherein the capture time and capture geolocation is associated with captured media as metadata.

5. The platform of claim 4, wherein the metadata is embedded in the media.

6. The platform of claim 1, wherein the radius is about 10 to about 10,000 meters.

7. The platform of claim 6, wherein the radius is about 500 meters.

8. The platform of claim 1, wherein the time interval is about 10 to about 10,000 seconds.

9. The platform of claim 8, wherein the time interval is about 300 seconds.

10. The platform of claim 1, wherein the mobile application further comprises a software module configured to view a media stream.

11. The platform of claim 1, wherein the mobile application further comprises a software module configured to apply one or more media filters to captured media.

12. The platform of claim 11, wherein the software module configured to transmit captured media to a server application transmits a filtered and an unfiltered version of the media.

13. The platform of claim 11, wherein the software module configured to transmit captured media to a server application transmits a filter setting and an unfiltered version of the media.

14. The platform of claim 1, wherein the mobile application further comprises a software module configured to present a gallery of captured media.

15. The platform of claim 1, wherein the media stream comprises reduced size reference media.

16. The platform of claim 15, wherein the mobile application further comprises a software module configured to allow download of media in the media stream in full size.

17. The platform of claim 1, wherein the mobile application further comprises a software module configured to allow purchase of media in the media stream in full size.

18. The platform of claim 1, wherein the mobile application further comprises a software module configured to manage captured media sharing settings.

19. The platform of claim 18, wherein the sharing settings comprise an unlimited mode and a limited mode.

20. The platform of claim 1, wherein the mobile application further comprises a software module configured to manage media stream receipt settings.

21. The platform of claim 20, wherein the receipt settings comprise an unlimited mode and a limited mode.

22. Non-transitory computer-readable storage media encoded with a computer program including instructions executable by a processor to create a mobile application for instant media sharing, the mobile application comprising:
a. a software module configured to determine geolocation;
b. a software module configured to capture media;
c. a software module configured to transmit captured media to a server, each captured media associated with a capture time and a capture geolocation; and
d. a software module configured to view an individual media stream provided by the server, the media stream comprising transmitted media for which a user is identified as a recipient user, a recipient user present within a radius about a capture geolocation during a time interval about a capture time.

23. Non-transitory computer-readable storage media encoded with a computer program including instructions executable by a processor to create a server application for instant media sharing, the server application comprising:
a. a database of geolocation information, the geolocation information associated with each user of a mobile application;
b. a software module configured to receive media, each media captured and transmitted by a user of the mobile application, each media associated with a capture time and a capture geolocation; and
c. a software module configured to provide an individual media stream to each user of the mobile application, the media stream comprising received media for which a user is identified as a recipient user, a recipient user present within a radius about a capture geolocation during a time interval about a capture time.
